(19) United States
(12) Patent Application Publication
(10) Pub. No.: US 2007/0028595 A1
(43) Pub. Date: Feb. 8, 2007

(54) High pressure gas turbine engine having reduced emissions

(76) Inventors: Hukam Chand Mongia, West Chester, OH (US); George Chia-Chun Hsiao, West Chester, OH (US); Shui-Chi Li, West Chester, OH (US); Shih-Yang Hsieh, West Chester, OH (US); Alfred Albert Mancini, Cincinnati, OH (US); David Louis Burrus, Cincinnati, OH (US); Marie Ann McMasters, Mason, OH (US); Duane Douglas Thomsen, Lebanon, OH (US)

Correspondence Address: James P. Davidson, 8375 Ashmont Way, Mason, OH, 45040, US

(21) Appl. No.: 11/188,483

(22) Filed: Jul. 25, 2005

(51) Int. Cl. F02K 3/04; F23R 3/14

(52) U.S. Cl. 60/226.1; 60/748

(57) ABSTRACT

A gas turbine engine having a longitudinal centerline axis therethrough, including a fan section at a forward end of the gas turbine engine for producing a first compressed air flow; a first compressor positioned downstream of the fan section and in flow communication with at least a portion of the first compressed air flow, wherein the first compressor produces a second compressed air flow having a designated pressure; a combustor positioned downstream of the first compressor and in flow communication with second compressed air flow, wherein the combustor produces combustion products from a mixture of fuel and air; a first turbine positioned downstream of the combustor and in flow communication with combustion products, wherein the first turbine powers the first compressor by means of a first rotatable drive shaft connected therebetween; and, a second turbine positioned downstream of the first turbine and in flow communication with the combustion products exiting the first turbine, wherein the second turbine powers the fan section by means of a second drive shaft connected therebetween. The gas turbine engine produces no more than a predetermined amount of emissions during an operating cycle.

### BACKGROUND OF THE INVENTION

The present invention relates to gas turbine engines having a high pressure ratio and, more particularly, to a staged combustion system for the gas turbine engine which is configured to minimize the production of undesirable combustion product components over the engine operating regime.

Air pollution concerns worldwide have led to stricter emissions standards both domestically and internationally. Aircraft are governed by both Environmental Protection Agency (EPA) and International Civil Aviation Organization (ICAO) standards. These standards regulate the emission of oxides of nitrogen (NOx), unburned hydrocarbons (HC), and carbon monoxide (CO) from aircraft in the vicinity of airports, where they contribute to urban photochemical smog problems. Such standards are driving the design of gas turbine engine combustors, which also must be able to accommodate the desire for efficient, low cost operation and reduced fuel consumption. In addition, the engine output must be maintained or even increased.

It will be appreciated that engine emissions generally fall into two classes: those formed because of high flame temperatures (NOx) and those formed because of low flame temperatures which do not allow the fuel-air reaction to proceed to completion (HC and CO). Balancing the operation of a combustor to allow efficient thermal operation of the engine, while simultaneously minimizing the production of undesirable combustion products, is difficult to achieve. In that regard, operating at low combustion temperatures to lower the emissions of NOx can also result in incomplete or partially incomplete combustion, which can lead to the production of excessive amounts of HC and CO, as well as lower power output and lower thermal efficiency. High combustion temperature, on the other hand, improves thermal efficiency and lowers the amount of HC and CO, but oftentimes results in a higher output of NOx.

One way of minimizing the emission of undesirable gas turbine engine combustion products has been through staged combustion. In such an arrangement, the combustor is provided with a first stage burner for low speed and low power conditions so the character of the combustion products is more closely controlled. A combination of first and second stage burners is provided for higher power output conditions, which attempts to maintain the combustion products within the emissions limits.

Another way that has been proposed to minimize the production of such undesirable combustion product components is to provide for more effective intermixing of the injected fuel and the combustion air. In this way, burning occurs uniformly over the entire mixture and reduces the level of HC and CO that results from incomplete combustion. While numerous mixer designs have been proposed over the years to improve the mixing of the fuel and air, improvement in the levels of undesirable NOx formed under high power conditions (i.e., when the flame temperatures are high) is still desired.

One mixer design that has been utilized is known as a twin annular premixing swirler (TAPS), which is disclosed in the following U.S. Pat. Nos.: 6,354,072; 6,363,726; 6,367,262; 6,381,964; 6,389,815; 6,418,726; 6,453,660; 6,484,489; and, 6,865,889. Published U.S. patent application 2002/0178732 also depicts certain embodiments of the TAPS mixer. It will be understood that the TAPS mixer assembly includes a pilot mixer which is supplied with fuel during the entire engine operating cycle and a main mixer which is supplied with fuel only during increased power conditions of the engine operating cycle.

While the design of the mixer assembly is able to improve mixing of fuel and air, and therefore reduce the emissions generated by the gas turbine engine, it has been found that the configuration and operation of the overall combustion system needs to be reconsidered if emissions are to meet desired levels without adversely affecting performance. This not only involves sizing the combustor properly, but also orienting and shaping the combustion chamber with respect to the mixer assemblies and the turbine nozzle. Further, the various hardware components of the combustor should be consistent with the air distribution requirements for cooling and lean burning, given the amount of compressed air flow provided to the combustor.

Accordingly, there is a desire for a gas turbine engine combustor in which the production of undesirable combustion product components is minimized over a wide range of engine operating conditions. More specifically, it is desired that such combustor retain required performance levels and characteristics. Further, a mixer assembly for such gas turbine engine combustor is desired which provides increased mixing of fuel and air so as to create a more uniform mixture. Modification of the combustor liners and combustion chamber is also desired so as to enable optimal use of the compressed air to the combustor.

### BRIEF SUMMARY OF THE INVENTION

In a first exemplary embodiment of the invention, a gas turbine engine having a longitudinal centerline axis therethrough is disclosed as including: a fan section at a forward end of the gas turbine engine for producing a first compressed air flow; a first compressor positioned downstream of the fan section and in flow communication with at least a portion of the first compressed air flow, wherein the first compressor produces a second compressed air flow having a designated pressure; a combustor positioned downstream of the first compressor and in flow communication with second compressed air flow, wherein the combustor produces combustion products from a mixture of fuel and air, a first turbine positioned downstream of the combustor and in flow communication with combustion products, wherein the first turbine powers the first compressor by means of a first rotatable drive shaft connected therebetween; and, a second turbine positioned downstream of the first turbine and in flow communication with the combustion products exiting the first turbine, wherein the second turbine powers the fan section by means of a second drive shaft connected therebetween. The gas turbine engine produces no more than a predetermined amount of emissions during an operating cycle.

In a second exemplary embodiment of the invention, a combustor of a gas turbine engine is disclosed as including: an annular dome portion at an upstream end having an outer end, an inner end and a plurality of circumferentially spaced openings therethrough; an outer liner connected to the outer end of the dome portion; an inner liner connected to the inner end of the dome portion and radially spaced from the outer liner to define a combustion chamber therebetween; a mixing assembly aligned with and located adjacent to each dome portion opening, and, a turbine nozzle located at a downstream end of the combustion chamber. The combustion chamber is configured so that a centerline axis through each mixing assembly is in substantial alignment with a center point of the turbine nozzle.

In accordance with a third embodiment of the present invention, a combustor for a gas turbine engine is disclosed as including: an annular dome portion at an upstream end having an outer end, an inner end and a plurality of circumferentially spaced openings therethrough; an outer liner connected to the outer end of the dome portion; an inner liner connected to the inner end of the dome portion and radially spaced from said outer liner to define a combustion chamber therebetween; a mixing assembly aligned with and located adjacent to each dome portion opening; and, a turbine nozzle located at a downstream end of the combustion chamber. The outer and inner liners only have openings therethrough in flow communication with the compressed air for cooling.

### BRIEF DESCRIPTION OF THE DRAWINGS

FIG. 1 is a diagrammatic view of a high bypass turbofan gas turbine engine;

FIG. 2 is a longitudinal, cross-sectional view of a prior art gas turbine engine combustor having a staged arrangement;

FIG. 3 is an enlarged, partial perspective view of the outer liner depicted in FIG. 2;

FIG. 4 is a longitudinal, cross-sectional view of a gas turbine engine combustor in accordance with the present invention;

FIG. 5 is an enlarged, cross-sectional view of an exemplary embodiment for the mixer assembly of the present invention;

FIG. 6 is an enlarged, partial perspective view of the outer liner depicted in FIG. 4; and,

FIG. 7 is an enlarged, partial perspective view of an alternative outer liner design which could be utilized in the combustor depicted in FIG. 4.

### DETAILED DESCRIPTION OF THE INVENTION

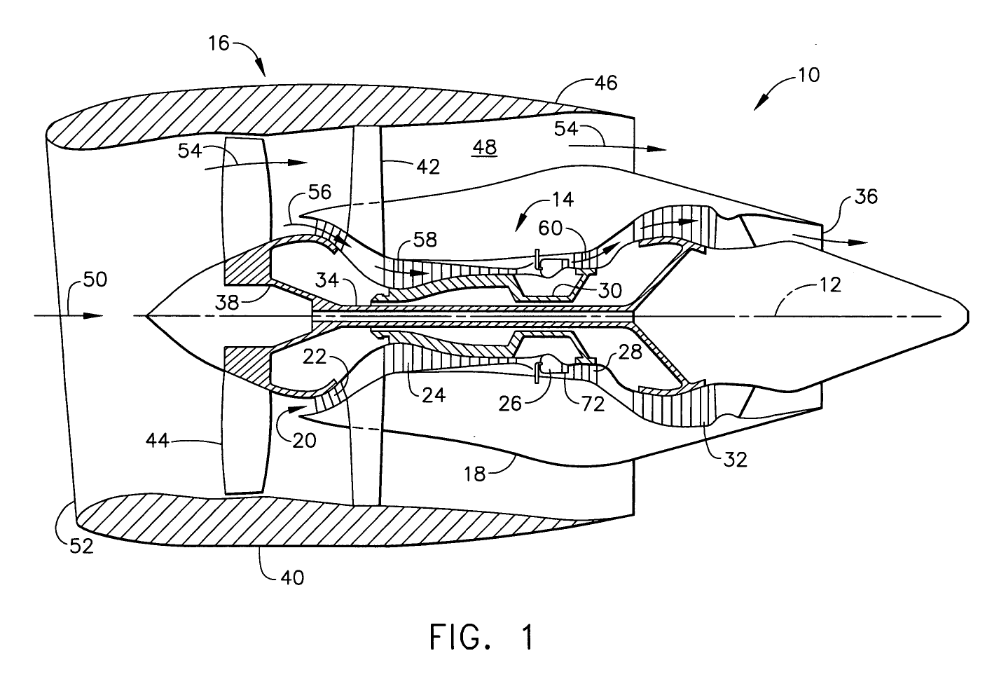

Referring now to the drawings in detail, wherein identical numerals indicate the same elements throughout the figures, FIG. 1 schematically depicts an exemplary gas turbine engine 10 (high bypass type) utilized with aircraft having a longitudinal or axial centerline axis 12 therethrough for reference purposes. Engine 10 preferably includes a core gas turbine engine generally identified by numeral 14 and a fan section 16 positioned upstream thereof Core engine 14 typically includes a generally tubular outer casing 18 that defines an annular inlet 20. Outer casing 18 further encloses and supports a booster compressor 22 for raising the pressure of the air that enters core engine 14 to a first pressure level. A high pressure, multi-stage, axial-flow compressor 24 receives pressurized air from booster 22 and further increases the pressure of the air. The pressurized air flows to a combustor 26, where fuel is injected into the pressurized air stream to raise the temperature and energy level of the pressurized air. The high energy combustion products flow from combustor 26 to a first (high pressure) turbine 28 for driving high pressure compressor 24 through a first (high pressure) drive shaft 30, and then to a second (low pressure) turbine 32 for driving booster compressor 22 through a second (low pressure) drive shaft 34 that is coaxial with first drive shaft 30. After driving each of turbines 28 and 32, the combustion products leave core engine 14 through an exhaust nozzle 36 to provide propulsive jet thrust.

Fan section 16 includes a rotatable, axial-flow fan rotor 38 that is surrounded by an annular fan casing 40. It will be appreciated that fan casing 40 is supported from core engine 14 by a plurality of substantially radially-extending, circumferentially-spaced support struts 42. In this way, fan casing 40 encloses fan rotor 38 and fan rotor blades 44. Downstream section 46 of fan casing 40 extends over an outer portion of core engine 14 to define a secondary, or bypass, airflow conduit 48 that provides additional propulsive jet thrust.

From a flow standpoint, it will be appreciated that an initial air flow, represented by arrow 50, enters gas turbine engine 10 through an inlet 52 to fan casing 40. Air flow 50 passes through fan blades 44 and splits into a first compressed air flow (represented by arrow 54) that moves through conduit 48 and a second compressed air flow (represented by arrow 56) which enters booster compressor 22.

The pressure of second compressed air flow 56 is increased and enters high pressure compressor 24, as represented by arrow 58. After mixing with fuel and being combusted in combustor 26, combustion products 60 exit combustor 26 and flow through first turbine 28. Combustion products 60 then flow through second turbine 32 and exit exhaust nozzle 36 to provide thrust for gas turbine engine 10.

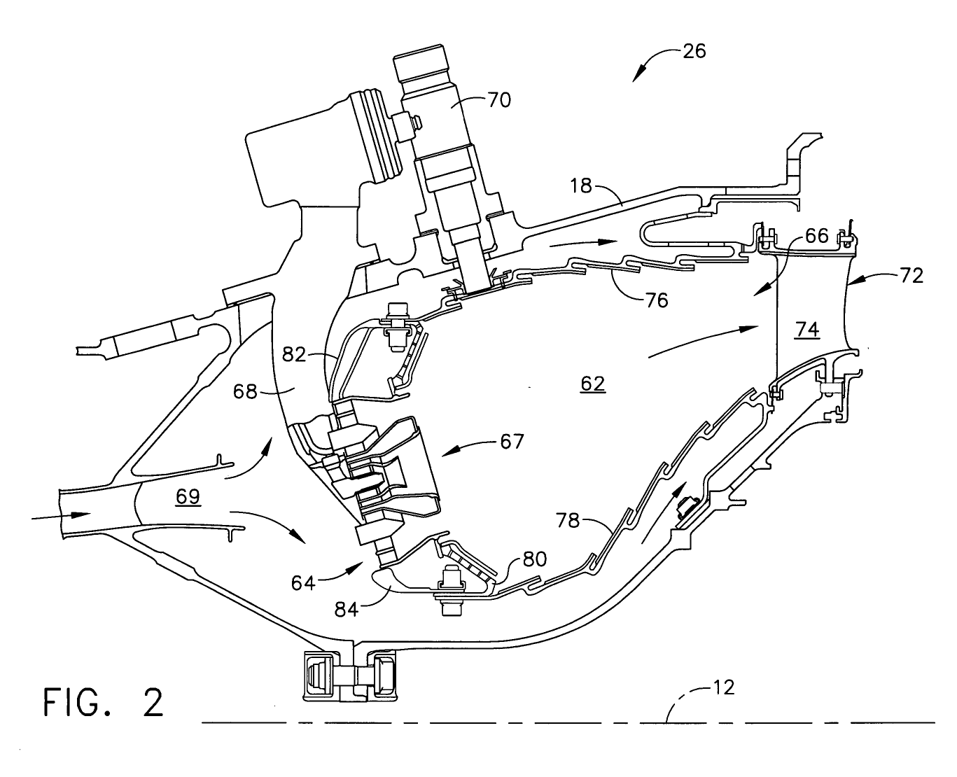

As seen in FIG. 2, a prior art combustor 26 includes an annular combustion chamber 62 that is coaxial with longitudinal axis 12, as well as an inlet 64 and an outlet 66. As noted above, combustor 26 receives an annular stream of pressurized air from a high pressure compressor discharge outlet 69. A portion of this compressor discharge air flows into a mixing assembly 67, where fuel is also injected from a fuel nozzle 68 to mix with the air and form a fuel-air mixture that is provided to combustion chamber 62 for combustion. Ignition of the fuel-air mixture is accomplished by a suitable igniter 70, and the resulting combustion gases 60 flow in an axial direction toward and into an annular, first stage turbine nozzle 72. Nozzle 72 is defined by an annular flow channel that includes a plurality of radially-extending, circularly-spaced nozzle vanes 74 that turn the gases so that they flow angularly and impinge upon the first stage turbine blades of first turbine 28. As shown in FIG. 1, first turbine 28 preferably rotates high pressure compressor 24 via first drive shaft 30.

Low pressure turbine 32 preferably drives booster compressor 24 and fan rotor 38 via second drive shaft 34.

More specifically, combustion chamber 62 is housed within an engine outer casing 18 and is defined by an annular combustor outer liner 76, a radially-inwardly positioned annular combustor inner liner 78, and a dome plate 80 at its upstream end.

The arrows in FIG. 2 show the directions in which compressor discharge air flows within combustor 26. As shown, part of the air flows over the outermost surface of outer liner 76, part flows into combustion chamber 62, and part flows over the innermost surface of inner liner 78. The distribution of compressor discharge air within combustion chamber 62 for rich-dome combustor systems, prior to the use of the TAPS mixer, involved approximately 18% of such air being provided to the mixer/nozzle and approximately 32% of the air being supplied to the dome area overall. The average amount of compressor discharge air being utilized as primary or dilution air through dilution openings 77 is approximately 37% and the average total cooling air is approximately 43%.

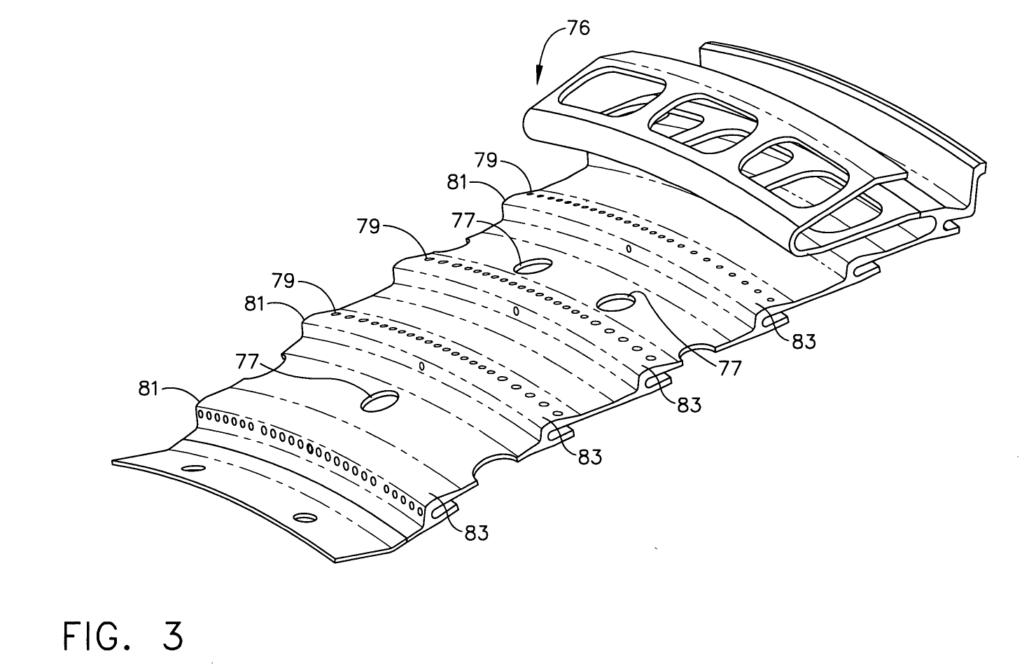

As seen in FIG. 3 with respect to outer liner 76, outer and inner liners 76 and 78 are provided with a plurality of dilution openings 77 to allow additional air to enter combustion chamber 62 for completion of the combustion process before the combustion products enter turbine nozzle 72. Additionally, it will be seen that outer liner 76 and inner liner 78 have a stepped form to include a plurality of annular step portions 81 that are defined by relatively short, inclined, outwardly-flaring annular panels 83 that include a plurality of smaller, circularly-spaced cooling air apertures 79 for allowing some of the air that flows along the outermost surfaces of outer and inner liners 76 and 78, respectively, to flow into the interior of combustion chamber 62. Those inwardly-directed air flows pass along the inner surfaces of outer and inner liners 76 and 78 that face the interior of combustion chamber 62, where a film of cooling air is provided along the inwardly-facing surfaces of each of inner liner 76 and outer liner 78 at respective intermediate annular panels 83. It will be appreciated that dilution openings 77 typically are approximately 0.50 inch in diameter, whereas cooling apertures 79 are approximately 0.05 inch in diameter. For cooling boles in liners employing multi-hole cooling, the diameter is typically approximately 0.02 inch. Thus, dilution openings for combustor liners are approximately 10-25 times greater in size than the cooling apertures therein.

It will be understood that a plurality of axially-extending mixing assemblies 67 are disposed in a circular array at the upstream end of combustor 26 and extend into inlet 64 of annular combustion chamber 62. Such mixing assemblies 67 are consistent with the TAPS mixers shown and described in the U.S. patents identified hereinabove. It will be seen that annular dome plate 80 extends inwardly and forwardly to define an upstream end of combustion chamber 62 and has a plurality of circumferentially spaced openings formed therein for receiving mixing assemblies 67. For their part, upstream portions of each of inner and outer liners 76 and 78, respectively, are spaced from each other in a radial direction and define an outer cowl 82 and an inner cowl 84. The spacing between the forwardmost ends of outer and inner cowls 82 and 84 defines combustion chamber inlet 64 to provide an opening to allow compressor discharge air to enter combustion chamber 62.

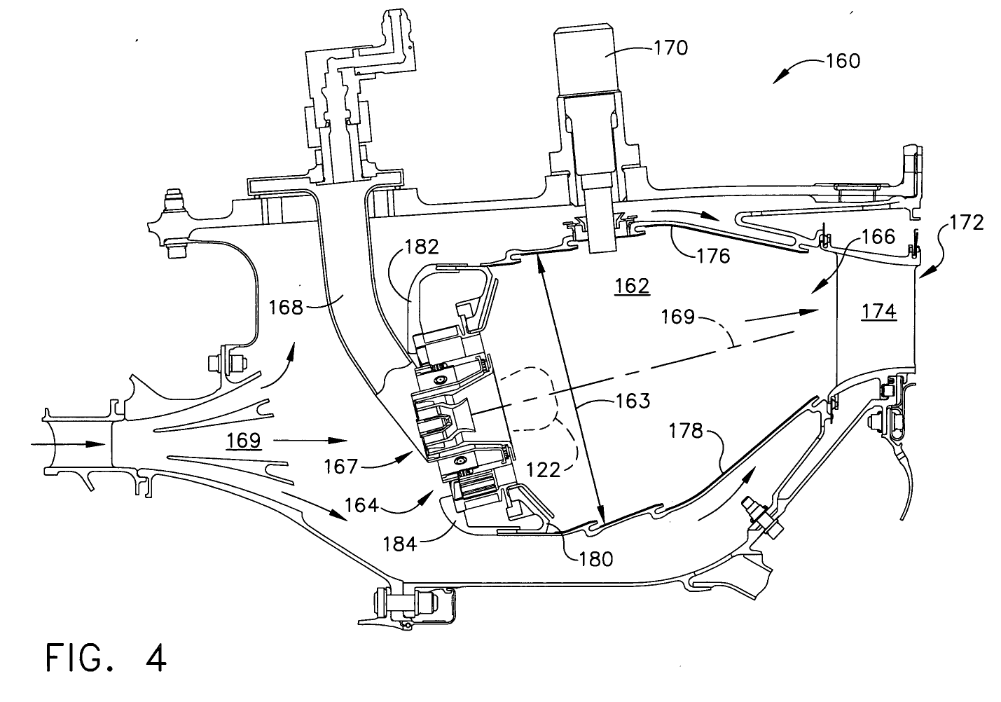

As seen in FIG. 4, combustor 160 is similar to combustor 60 described herein in that it has a single annular design and includes the same types of components. Accordingly, combustor 160 includes an annular combustion chamber 162 that is coaxial with longitudinal axis 12, as well as an inlet 164 and an outlet 166. As noted above, combustor 160 receives an annular stream of pressurized air from a high pressure compressor discharge outlet 169. A portion of this compressor discharge air flows into a mixing assembly 167, where fuel is also injected from a fuel nozzle 168 to mix with the air and form a fuel-air mixture that is provided to combustion chamber 162 for combustion. Ignition of the fuel-air mixture is accomplished by a suitable igniter 170, and the resulting combustion gases 60 flow in an axial direction toward and into an annular, first stage turbine nozzle 172. Nozzle 172 is defined by an annular flow channel that includes a plurality of radially-extending, circularly-spaced nozzle vanes 174 that turn the gases so that they flow angularly and impinge upon the first stage turbine blades of first turbine 28.

More specifically, combustion chamber 162 is housed within an engine outer casing 118 and is defined by an annular combustor outer liner 176, a radially-inwardly positioned annular combustor inner liner 178, and a dome plate 180 at its upstream end. The arrows in FIG. 4 show the directions in which compressor discharge air flows within combustor 160. As shown, part of the air flows over the outermost surface of outer liner 176, part flows into combustion chamber 162, and part flows over the innermost surface of inner liner 178.

Contrary to the prior combustor, however, combustion chamber 162 thereof is generally symmetrical when viewed in cross-section and has a relatively larger dome height 163. This stems from the higher pressure ratios of the current gas turbine engines, which now are 30 and above. It will be appreciated by those skilled in the art that the pressure ratio of a gas turbine engine is generally defined as the ratio of second compressed air flow 56 (i.e., compressor discharge air) to an ambient pressure outside gas turbine engine 10. In fact, some gas turbine engines have pressure ratios greater than 40. It has been found that combustion chamber 162 should be sized according to the pressure ratio of gas turbine engine 10, where its volume and dome height 163 is increased as the pressure ratio of the gas turbine engine increases.

It is also preferred that combustion chamber 162, as well as outer liner 176, inner liner 178 and dome plate 180, be configured so that mixing assemblies 167 provided at the upstream end thereof have a centerline axis 169 therethrough in substantial alignment with a center portion of turbine nozzle vanes 174.

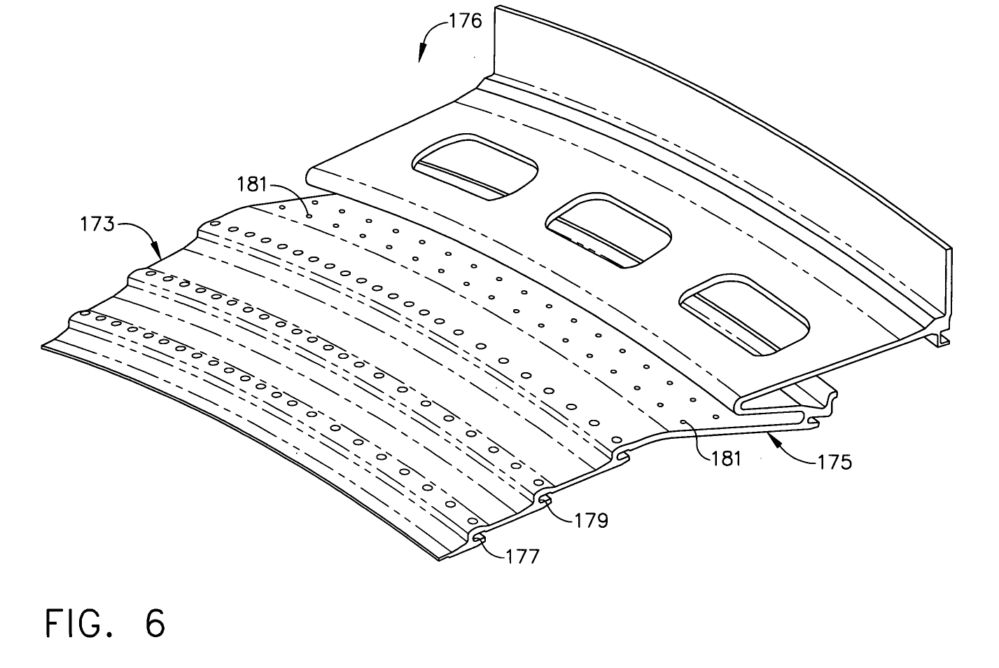

Outer and inner liners 176 and 178 of combustor 160 preferably are constructed so as to not include any dilution holes or openings. As seen in FIG. 6, one configuration for outer liner 176 is similar to a hybrid liner disclosed in U.S. Pat. No. 6,655,146 to Kutter et al. Accordingly, an upstream portion 173 is provided with slot film cooling and a downstream portion 175 is provided with multi-hole film cooling. It will be seen in FIG. 6 that slots 177 and 179 are provided in upstream portion 173, whereas patterns of cooling apertures 181 are provided in downstream portion 175. Since no portion of compressor discharge air is utilized for primary or dilution air, a much higher percentage may be provided to mixers 167 to facilitate lean burning of fuel in combustion chamber 162 (i.e., combustor 160 operates below stoichiometric conditions from an upstream end of combustion chamber 162 to a downstream end thereof).

In particular, the percentage of air provided to mixers 167 of the compressor discharge air supplied to combustor 160 is preferably greater than approximately 50-70% thereof. Approximately 4-6 times more air is provided to main mixer 104 (55-65% of compressor discharge air) than to pilot mixer 102 (8-15% of compressor discharge air). Thus, no more than approximately 30-40% of the compressor discharge air is provided as total cooling air for combustor 160. Of the total cooling air for combustor 160, approximately 5-15% of the compressor discharge air is provided as cooling air for dome 180 and approximately 15-25% thereof is provided as cooling air for outer and inner liners 176 and 178. It will also be appreciated that improvements in the variation in temperature along a given axial plane through outer and inner liners 176 and 178 have been experienced (no greater than approximately 140° F.). In addition, a pattern factor at a downstream end of combustion chamber 162 has improved to be no greater than approximately 1.1-1.3.

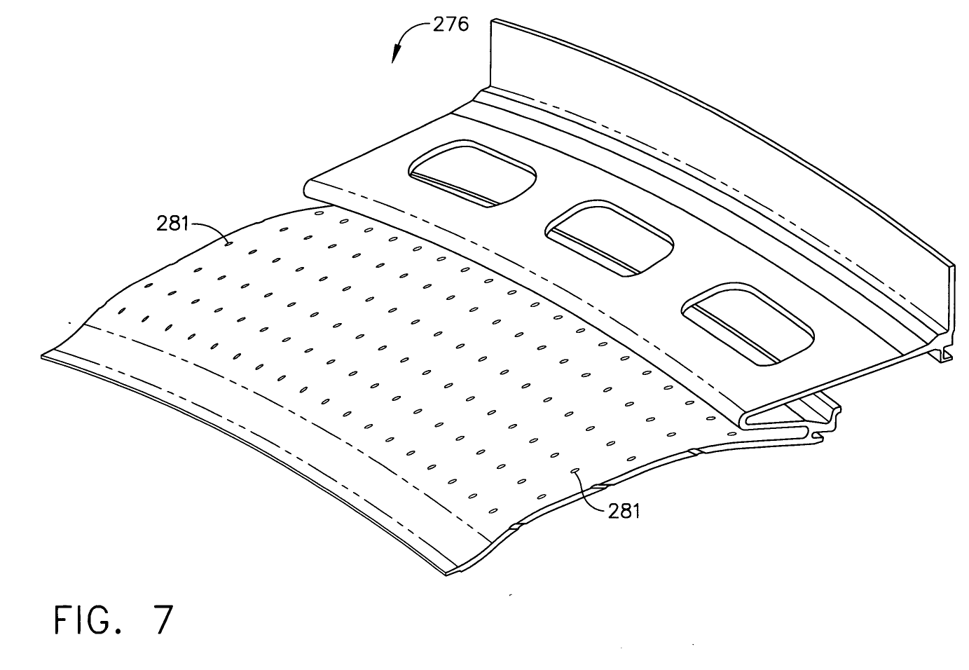

It will be seen in FIG. 7 that combustor 160 may utilize outer and inner liners having an alternative configuration (only outer liner 276 being shown). This design is similar to the liners having a multi-hole cooling pattern like those disclosed in U.S. Pat. No. 6,205,789 to Patterson et al., U.S. Pat. No. 6,408,629 to Harris et al., and U.S. Pat. No. 6,655,149 to Farmer et al. Contrary to these prior art liners, however, it will be again noted that only cooling apertures 281 are present in the current liners (i.e., no dilution openings). Besides allowing a reallocation of the compressor discharge air within combustor 160, the cooling issues and subsequent modifications of the hole pattern stemming from the presence of dilution openings in such prior liners are no longer applicable. The current liners 276 and 278 will therefore be able to provide more effective cooling, as well as benefit from easier manufacturing.

With respect to mixers 167 in combustor 160, it is preferred that they have one of or a combination of the configurations and/or features shown and described in a group of patent applications filed concurrently herewith having the following titles: “Mixer Assembly For Combustion Chamber Of A Gas Turbine Engine Having A Plurality Of Counter-Rotating Swirlers,” having Ser. No. ______/______,______; “Swirler Arrangement For Mixer Assembly Of A Gas Turbine Engine Combustor Having Shaped Passages,” having Ser. No. ______/______,______; “Mixer Assembly For Combustor Of A Gas Turbine Engine Having A Main Mixer With Improved Fuel Penetration,” having Ser. No. ______/______,______; and, “Air-Assisted Fuel Injector For Mixer Assembly Of A Gas Turbine Engine Combustor,” having Ser. No. ______/______,______. Each of these applications is owned by the assignee of the present invention and are hereby incorporated by reference.

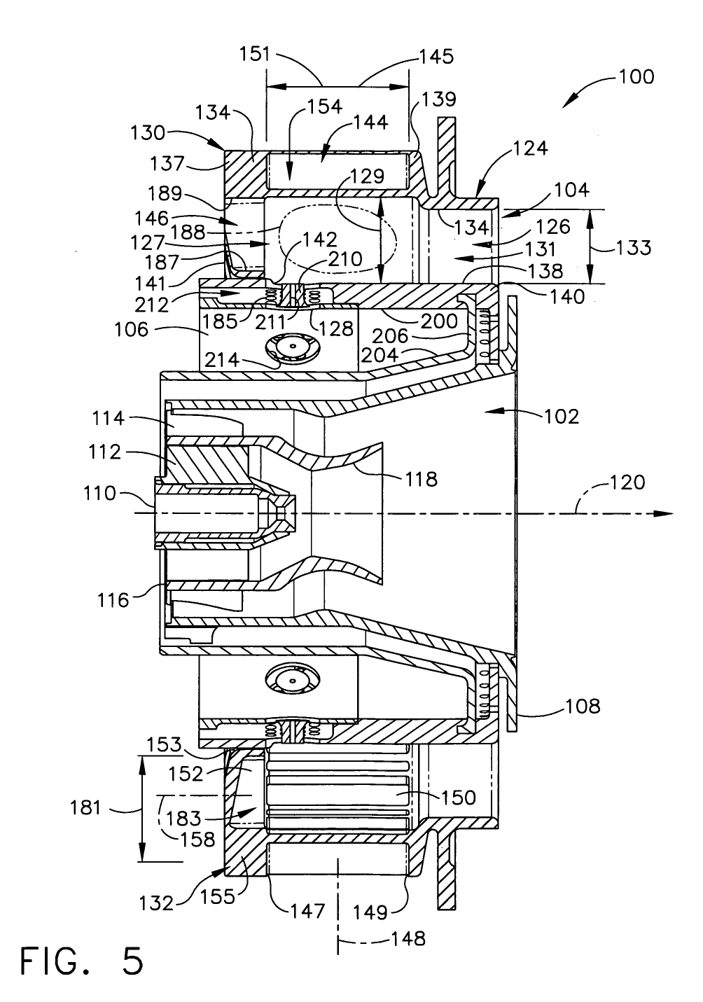

As seen in FIG. 5, an exemplary mixer assembly 100 preferably includes a pilot mixer 102, a main mixer 104, and a fuel manifold 106 positioned therebetween. More specifically, it will be seen that pilot mixer 102 preferably includes an annular pilot housing 108 having a hollow interior, as well as a pilot fuel nozzle 110 mounted in housing 108 and adapted for dispensing droplets of fuel to the hollow interior of pilot housing 108. Further, pilot mixer 102 preferably includes a first swirler 112 located at a radially inner position adjacent pilot fuel nozzle 110, a second swirler 114 located at a radially outer position from first swirler 112, and a splitter 116 positioned therebetween. Splitter 116 extends downstream of pilot fuel nozzle 110 to form a venturi 118 at a downstream portion. It will be understood that first and second pilot swirlers 112 and 114 are generally oriented parallel to a centerline axis 120 through mixing assembly 100 and include a plurality of vanes for swirling air traveling therethrough. Fuel and air are provided to pilot mixer 102 at all times during the engine operating cycle so that a primary combustion zone 122 is produced within a central portion of combustion chamber 162 (see FIG. 4).

Main mixer 104 further includes an annular main housing 124 radially surrounding pilot housing 108 and defining an annular cavity 126, a plurality of fuel injection ports 128 which introduce fuel into annular cavity 126, and a swirler arrangement identified generally by numeral 130. More specifically, annular cavity 126 is preferably defined by an upstream wall 132 and an outer radial wall 134 of a swirler housing 136, and by an inner radial wall 138 of a centerbody outer shell 140. It will be seen that inner radial wall 138 preferably also includes a ramp portion 142 located at a forward position along annular cavity 126. It will be appreciated that annular cavity 126 gently transitions from an upstream end 127 having a first radial length 129 to a downstream end 131 having a second radial height 133. The difference between first radial height 129 and second radial height 133 of annular cavity 126 is due primarily to outer radial wall 134 of swirler housing 136 incorporating a swirler 144 therein at upstream end 127. In addition, ramp portion 142 of inner radial wall 138 is preferably located within an axial length 145 of swirler 144.

It will be seen in FIG. 5 that swirler arrangement 130 preferably includes at least a first swirler 144 positioned upstream from fuel injection ports 128. As shown, first swirler 144 is preferably oriented substantially radially to centerline axis 120 through mixer assembly 100 and has an axis 148 therethrough. It will be noted that first swirler 144 includes a plurality of vanes 150 extending between first and second portions 137 and 139 of outer radial wall 134. It will be appreciated that vanes 150 are preferably oriented at an angle of approximately 30-70° with respect to axis 148. Vanes 150 will preferably each have a length 151 which is measured across opposite ends (i.e., in the axial direction relative to centerline axis 120 of mixing assembly 100). Since vanes 150 are substantially uniformly spaced circumferentially, a plurality of substantially uniform passages 154 are defined between adjacent vanes 150. It will be noted that vanes 150 preferably extend from upstream end 147 of swirler 144 to downstream end 149 thereof Nevertheless, vanes 150 may extend only part of the way from upstream end 147 to downstream end 149 so that the tips thereof are stepped or lie on a different annulus. It will further be understood that swirler 144 may include vanes having different configurations so as to shape the passages in a desirable manner, as disclosed in a patent application entitled “Swirler Arrangement For Mixer Assembly Of A Gas Turbine Engine Combustor Having Shaped Passages,” which is also filed concurrently herewith by the assignee of the present invention and is hereby incorporated herein.

Swirled air may also be provided at upstream end 127 of annular cavity 126 via a series of passages formed in upstream wall 132 of swirler housing, as shown and described in a patent application entitled, “Mixer Assembly For Combustor Of A Gas Turbine Engine Having A Main Mixer With Improved Fuel Penetration, which is filed concurrently herewith and is owned by the assignee of the present invention. Rather, it is seen from FIG. 5 that a second swirler 146 is preferably provided which is oriented substantially axially to centerline axis 120. Second swirler 146 includes a plurality of vanes 152 extending between inner and outer portions 153 and 155 of upstream wall 132. It will be appreciated that vanes 152 are preferably oriented at an angle of approximately 0-60° with respect to an axis 158 extending therethrough and parallel to centerline axis 120. Vanes 152 will preferably each have a length 180 which is measured across opposite ends (i.e., in the radial direction relative to centerline axis 120 of mixing assembly 100). Since vanes 152 are substantially uniformly spaced circumferentially, a plurality of substantially uniform passages 182 are defined between adjacent vanes 152. It will be noted that vanes 152 preferably extend from inner end 184 of swirler 146 to outer end 186 thereof Nevertheless, vanes 152 may extend only part of the way from inner end 184 to outer end 186 so that the tips thereof are stepped or lie on a different annulus. It will further be understood that swirler 146 may include vanes having different configurations so as to shape the passages in a desirable manner, as disclosed in a patent application entitled “Swirler Arrangement For Mixer Assembly Of A Gas Turbine Engine Combustor Having Shaped Passages” and is utilized to provide the counter swirling flow in annular cavity 126.

It will be understood that air flowing through first swirler 144 will be swirled in a first direction and air flowing through second swirler 146 will preferably be swirled in a direction opposite the first direction. In this way, an intense mixing region 188 of air and fuel is created within annular cavity 126 having an enhanced total kinetic energy. By properly configuring swirlers 144 and 146, intense mixing region 188 is substantially centered within annular cavity 126, positioned axially adjacent fuel injection ports 128 and has a designated area. The configuration of the vanes in swirlers 144 and 146 may be altered to vary the swirl direction of air flowing therethrough and not be limited to the exemplary swirl directions indicated hereinabove.

It will be seen that length 151 of first swirler vanes 150 is preferably greater than length 180 of second swirler vanes 152. Accordingly, a relatively greater amount of air flows through first swirler 144 than through second swirler 146 due to the greater passage area therefor. The relative lengths of swirlers 144 and 146 may be varied as desired to alter the distribution of air therethrough, so the sizes depicted are only illustrative.

Fuel manifold 106, as stated above, is located between pilot mixer 102 and main mixer 104 and is in flow communication with a fuel supply. In particular, outer radial wall 138 of centerbody outer shell 140 forms an outer surface 200 of fuel manifold 106, and a shroud member 202 is configured to provide an inner surface 204 and an aft surface 206. Fuel injection ports 128 are in flow communication with fuel manifold and spaced circumferentially around centerbody outer shell 140. As shown and described in a patent application entitled “Mixer Assembly For Combustor Of A Gas Turbine Engine Having A Main Mixer With Improved Fuel Penetration,” filed concurrently herewith and also owned by the assignee of the present invention, fuel injection ports 128 are preferably positioned axially adjacent ramp portion 142 of centerbody outer shell 140 so that fuel is provided in upstream end 127 of annular cavity 126. In this way, fuel is preferably mixed with the air in intense mixing region 188 before entering downstream end 131 of annular cavity 126. Regardless of the axial location of fuel injection ports 128, it is intended that the fuel be injected at least a specified distance into a middle radial portion of annular cavity 126 and away from the surface of inner wall 138.

It will be appreciated that injection of the fuel into the desired location of annular cavity 126 is a function of providing an air flow therein which accommodates such injected fuel (instead of forcing the fuel against inner radial wall 138), as well as positioning fuel injection ports 128 so as to inject fuel in the manner best suited to the air flow. In addition, at least one row of circumferentially spaced purge holes 185 is provided adjacent to and between each fuel injection port 128 to assist the injected fuel in its intended path. Such purge holes 185 also assist in preventing injected fuel from collecting along inner radial wall 138.

In order to further facilitate injection of the fuel from fuel injection ports 128 into annular cavity 126, it is also preferred that a post member 210 having an inner passage 211 be associated with each such fuel injection port 128. It will be seen that post member 210 preferably extends from fuel injection port 128 through an air cavity 212 supplying compressed air to all applicable purge holes discussed hereinabove and through inner wall 138. In this way, fuel not only is injected directly into annular cavity 126, but the fuel is better able to travel into a middle annular portion of annular cavity 126 with the assistance of purge holes 185.

As shown in FIG. 5, a passage 214 is preferably provided which surrounds post member 210 and is in flow communication with air cavity 212 so that a jet of air envelops the fuel as it is injected into annular cavity 126. Accordingly, the fuel is better able to penetrate into annular cavity 126 a desired amount. In order to provide a swirl to the air jet provide by passage 214, a swirler member (not shown) may be provided around post member 210 which extends from fuel injection port 128 to outer surface 200 of fuel manifold 106.

In light of the improvements made in combustor 160, gas turbine engine 10 produces no more than a predetermined amount of emissions during an operating cycle. More specifically, gas turbine engine produces no more than approximately 15-30 grams of NOx per kilogram of fuel and no more than approximately 5-10 grams of CO per kilogram of fuel during the take-off and landing portions of the operating cycle. It has also been found that gas turbine engine 10 produces no more than approximately 8-12 grams of NOx per kilogram of fuel during a cruise portion of the operating cycle. Further, no more than approximately 50-60 grams of unburned hydrocarbons per kilogram of fuel is produced during the ground idle portion of the operating cycle. Gas turbine engine has a smoke number of no more than approximately 1-10 during the take-off and landing portions of the operating cycle and a smoke number of no more than approximately 1-7 during the cruise portion of such operating cycle.

Although particular embodiments of the present invention have been illustrated and described, it will be apparent to those skilled in the art that various changes and modifications can be made without departing from the spirit of the present invention. Accordingly, it is intended to encompass within the appended claims all such changes and modification that fall within the scope of the present invention.

What is claimed is:

1. A gas turbine engine having a longitudinal centerline axis therethrough, comprising:
(a) a fan section at a forward end of said gas turbine engine for producing a first compressed air flow;
(b) a first compressor positioned downstream of said fan section and in flow communication with at least a portion of said first compressed air flow, wherein said first compressor produces a second compressed air flow having a designated pressure;
(c) a combustor positioned downstream of said first compressor and in flow communication with said second compressed air flow, wherein said combustor produces combustion products from a mixture of fuel and air;
(d) a first turbine positioned downstream of said combustor and in flow communication with said combustion products, wherein said first turbine powers said first compressor by means of a first rotatable drive shaft connected therebetween; and,
(e) a second turbine positioned downstream of said first turbine and in flow communication with said combustion products exiting said first turbine, wherein said second turbine powers said fan section by means of a second drive shaft connected therebetween;
wherein said gas turbine engine produces no more than a predetermined amount of emissions during an operating cycle.

2. The gas turbine engine of claim 1, wherein said gas turbine engine produces no more than approximately 15-30 grams of NOx per kilogram of fuel during take-off and landing portions of the operating cycle.

3. The gas turbine engine of claim 1, wherein said gas turbine engine produces no more than approximately 5-10 grams of CO per kilogram of fuel during take-off and landing portions of the operating cycle.

4. The gas turbine engine of claim 1, wherein said gas turbine engine produces no more than approximately 50-60 grams of unburned hydrocarbons per kilogram of fuel during a ground idle portion of the operating cycle.

5. The gas turbine engine of claim 1, wherein said gas turbine engine has a smoke number of no more than approximately 1-10 during take-off and landing portions of the operating cycle.

6. The gas turbine engine of claim 1, wherein said gas turbine engine produces no more than approximately 8-12 grams of NOx per kilogram of fuel during a cruise portion of the operating cycle.

7. The gas turbine engine of claim 1, wherein said gas turbine engine has a smoke number of no more than approximately 1-7 during a cruise portion of the operating cycle.

8. The gas turbine engine of claim 1, wherein a ratio of said designated pressure of said second compressed air flow to an ambient pressure outside said gas turbine engine is at least approximately 30.

9. The gas turbine engine of claim 1, wherein a ratio of said designated pressure of said second compressed air flow to an ambient pressure outside said gas turbine engine is at least approximately 40.

10. The gas turbine engine of claim 1, said combustor further comprising a single annulus of mixing assemblies at an upstream end thereof.

11. The gas turbine engine of claim 1, wherein said combustor operates below stoichiometric conditions from an upstream end of a combustion chamber to a downstream end thereof.

12. The gas turbine engine of claim 1, said combustor further comprising:
(a) an annular dome portion at an upstream end having an outer end, an inner end and a plurality of circumferentially spaced openings therethrough;
(b) an outer liner connected to said outer end of said dome portion;
(c) an inner liner connected to said inner end of said dome portion and radially spaced from said outer liner to define a combustion chamber therebetween; and,
(d) a mixing assembly aligned with and located adjacent to each said dome portion opening;
wherein at least approximately 50% of said second compressed air flow is provided to said mixing assemblies.

13. The gas turbine engine of claim 12, wherein at least approximately 60% of said second compressed air flow is provided to said mixing assemblies.

14. The gas turbine engine of claim 12, wherein at least approximately 70% of said second compressed air flow is provided to said mixing assemblies.

15. The gas turbine engine of claim 12, wherein approximately 30-40% of said second compressed air flow is provided as total cooling air for said combustor.

16. The gas turbine engine of claim 12, wherein approximately 5-10% of said second compressed air flow is provided as cooling air for said dome portion.

17. The gas turbine engine of claim 12, wherein approximately 20-25% of said second compressed air flow is provided as cooling air for said outer and inner liners.

18. The gas turbine engine of claim 12, wherein none of said second compressed air flow is provided as dilution air for said combustion chamber.

19. The gas turbine engine of claim 12, wherein approximately 10-15% of said second compressed air flow is provided to a pilot mixer of said mixing assemblies.

20. The gas turbine engine of claim 12, wherein approximately 55-60% of said second compressed air flow is provided to a main mixer of said mixing assemblies.

21. The gas turbine engine of claim 12, wherein variation in temperature along a given axial plane through said outer and inner liners is no greater than approximately 140° F.

22. The gas turbine engine of claim 12, wherein said combustor has a pattern factor at a downstream end of said combustion chamber which is no greater than approximately 1.1-1.3.

23. The gas turbine engine of claim 12, each said mixing assembly further
(a) a pilot mixer including an annular pilot housing having a hollow interior and a pilot fuel nozzle mounted in said housing and adapted for dispensing droplets of fuel to said hollow interior of said pilot housing;
(b) a main mixer including:
(1) a main housing surrounding said pilot housing and defining an annular cavity;
(2) a plurality of fuel injection ports for introducing fuel into said cavity; and,
(3) a swirler arrangement including a plurality of swirlers positioned upstream from said fuel injection ports, wherein each swirler of said swirler arrangement has a plurality of vanes for swirling air traveling through such swirler to mix air and said droplets of fuel dispensed by said fuel injection ports; and,
(c) a fuel manifold positioned between said pilot mixer and said main mixer, wherein said plurality of fuel injection ports for introducing fuel into said main mixer cavity are in flow communication with said fuel manifold.

24. The gas turbine engine of claim 23, said swirler arrangement for said main mixer further comprising first, second and third swirlers oriented substantially radially to said centerline axis, wherein said first swirler is positioned upstream of said second swirler and said third swirler is positioned downstream of said second swirler.

25. The gas turbine engine of claim 23, at least one of said swirlers further comprising:
(a) a first plurality of vanes oriented at a first angle with respect to a centerline axis through said swirler arrangement; and,
(b) a second plurality of vanes oriented at a second angle with respect to said swirler arrangement centerline axis;
wherein a first type of passage is defined between adjacent vanes having a first configuration and a second type of passage is defined between adjacent vanes having a second configuration.

26. The gas turbine engine of claim 23, said swirler arrangement further comprising:
(a) a first swirler oriented substantially parallel to a centerline axis through said main mixer;
(b) a second swirler oriented substantially radially to said centerline axis; and,
(c) a third swirler oriented substantially radially to said centerline axis, wherein said third swirler is positioned downstream of said second swirler.

27. The gas turbine engine of claim 23, said annular cavity of said main mixer further comprising a ramp portion positioned adjacent an upstream end thereof and said fuel injection ports being positioned adjacent said ramp portion.

28. The gas turbine engine of claim 27, wherein said fuel injection ports are positioned upstream of said ramp portion.

29. The gas turbine engine of claim 27, wherein said fuel injection ports are positioned downstream of said ramp portion.

30. The gas turbine engine of claim 23, said main mixer of said mixing assemblies further comprising a passage surrounding each said fuel injection port, wherein air is provided to assist said fuel in penetrating said annular cavity and being atomized therein.

31. A combustor of a gas turbine engine, comprising:
(a) an annular dome portion at an upstream end having an outer end, an inner end and a plurality of circumferentially spaced openings therethrough;
(b) an outer liner connected to said outer end of said dome portion;
(c) an inner liner connected to said inner end of said dome portion and radially spaced from said outer liner to define a combustion chamber therebetween;
(d) a mixing assembly aligned with and located adjacent to each said dome portion opening; and,
(e) a turbine nozzle located at a downstream end of said combustion chamber;
wherein said combustion chamber is configured so that a centerline axis through each said mixing assembly is in substantial alignment with a center point of said turbine nozzle.

32. The combustor of claim 31, wherein said combustion chamber is substantially symmetrical in cross-section.

33. The combustor of claim 31, said combustion chamber having a dome height which is a function of a pressure ratio for said gas turbine engine.

34. A combustor for a gas turbine engine, comprising:
(a) an annular dome portion at an upstream end having an outer end, an inner end and a plurality of circumferentially spaced openings therethrough;
(b) an outer liner connected to said outer end of said dome portion;
(c) an inner liner connected to said inner end of said dome portion and radially spaced from said outer liner to define a combustion chamber therebetween;
(d) a mixing assembly aligned with and located adjacent to each said dome portion opening; and,
(e) a turbine nozzle located at a downstream end of said combustion chamber;
wherein said outer and inner liners only have openings therethrough in flow communication with said compressed air for cooling.

35. The combustor of claim 34, wherein said outer and inner liner openings have a diameter no larger than approximately 0.05 inch.

36. The combustor of claim 34, wherein no more than approximately 30% of compressor discharge air provided thereto is for cooling of said combustor.
